(19) United States
(12) Patent Application Publication
(10) Pub. No.: US 2022/0033978 A1
(43) Pub. Date: Feb. 3, 2022

(54) PROCESS FOR ELECTROLYTIC PRODUCTION OF AMMONIA FROM NITROGEN USING METAL SULFIDE CATALYTIC SURFACE

(71) Applicant: ATMONIA EHF., Reykjavik (IS)

(72) Inventors: Egill SKULASON, Reykjavik (IS); Younes ABGHOUI, Reykjavik (IS)

(21) Appl. No.: 17/298,483

(22) PCT Filed: Nov. 29, 2019
(86) PCT No.: PCT/IS2019/050015

§ 371 Date: May 28, 2021

(30) Foreign Application Priority Data
Nov. 29, 2018 (IS) 050246

(51) Int. Cl. C25B 1/27; C25B 1/04; C25B 9/17; C25B 11/075

(52) U.S. Cl. CPC C25B 1/27; C25B 11/075; C25B 9/17; C25B 1/04

(57) ABSTRACT

A process is provided for producing ammonia comprising feeding N2 to an electrolytic cell that comprises a cathode with a transition metal sulfide catalytic surface. Also provided a system for generating ammonia with the process, comprising a transition metal sulfide catalyst.

### FIELD

The invention is within the field of process chemistry, and specifically relating to the production of ammonia from nitrogen with electrolytic methods, and new transition metal sulfide catalysts therefor.

### INTRODUCTION

Ammonia is one of the industrial chemicals produced in largest amount worldwide. It is conventionally produced with the so-called Haber-Bosch process, which is energy demanding and requires high pressure (150-350 atm) and high temperature (350-550° C.).

The triple bond in molecular nitrogen N₂ is very strong and as a consequence nitrogen is very inactive and frequently used as an inert gas. It is broken down by the harsh conditions in the Haber-Bosch process, however, it is also broken down at ambient conditions in a natural process, by microorganisms through nitrogenase enzyme. The active site of nitrogenase is a MoFe₇S₉N cluster that catalyses ammonia formation from solvated protons, electrons and atmospheric nitrogen through the electrochemical reaction

N₂+8H⁺+8e−→2NH₃+H₂ (1)

Therefore, an attractive vision is to mimic the natural enzymatic process in a man-made, commercial installation where instead of a separate H₂(g) production process, the protons would be generated via water splitting at the anode and transported through an aqueous solution while the electrons would be driven externally to the electrode surface by an applied electric potential. If that is realized, small-scale and more dispersed ammonia plants could be developed, which could be operating at milder operating conditions. Recent efforts by the present applicants has resulted in practical low-cost methods for producing ammonia electrochemically, with new catalytical surfaces, as described in WO2015189865, providing methods and systems for ammonia production at ambient room temperature and atmospheric pressure with low-cost equipment.

Two recent publications have reported that the highest ammonia reaction rate and current efficiency so far reached are 1.59×10⁻⁹ mol s⁻¹ cm⁻², with a current efficiency of 11.56% at −1.19 V vs. RHE, using N-doped carbon nanospikes in 0.25 M LiClO₄ electrolyte at ambient conditions (1). The other study was conducted by Zhou et al. where the highest current efficiency of 60% was obtained, but with a reaction rate of only 4.1×10⁻¹² mol cm⁻² s⁻¹ (2). However, production rates nearing that of commercial viability at moderate operational environments are yet to be reached. The N₂ reduction reaction (NRR) is difficult to catalyse to ammonia in aqueous electrolytes at ambient conditions due to the exceptional stability of the N₂ triple bond as well as the hydrogen evolution reaction (HER) that is a competing reaction with usually higher current efficiency (CE).

### SUMMARY

The above features along with additional details of the invention, are described further in the examples below, which are intended to further illustrate the invention but are not intended to limit its scope in any way.

The present inventors have found that certain transition metal sulfide catalysts may be employed in electrochemical processes for producing ammonia. This has led to the present invention, that makes possible efficient ammonia production at ambient room temperature and atmospheric pressure.

The present invention provides a process for producing ammonia comprising feeding N₂ to an electrolytic cell that comprises a cathode, an anode, and an electrolyte solution and that comprises at least one source of protons, allowing the N₂ to come into contact with an electrode surface of the cathode in the electrolytic cell, wherein said electrode surface comprises a catalyst surface comprising at least one transition metal sulfide, and running a current through said electrolytic cell, whereby nitrogen reacts with protons to form ammonia.

The invention also provides a system for the generation of ammonia, in particular a system that carries out the process/method of generating ammonia as disclosed herein. Thus, the invention provides a system for generating ammonia that comprises at least one electrochemical cell comprising at least one cathode electrode having a catalytic surface, wherein the component of the catalytic material comprises one or more transition metal sulfide.

### BRIEF DESCRIPTION OF THE FIGURES

The skilled person will understand that the figures, described below, are for illustration purposes only. The figures are not intended to limit the scope of the present teachings in any way.

FIG. 1. Unit cell and top views of the low-index surfaces of metal sulfide.

FIG. 2. Comparison of the free energy of adsorption of NNH to that of H on the surface of sulfides.

FIG. 3. Free energy diagrams for ammonia formation on the surface of transition metal sulfides via the associative mechanism.

FIG. 4. Free energy diagrams for ammonia formation on the surface of sulfides via the dissociative mechanism.

FIG. 5. Comparison of the free energy of adsorption of N to that of H on the clean surface of sulfides for the dissociative mechanism.

FIG. 6. Scaling relations between the free energy of the intermediates as a function of the free energy of *NNH as descriptor for the associative mechanism.

FIG. 7. Scaling relations between the free energy of the intermediates as a function of the free energy of *N as descriptor for the dissociative mechanism.

FIG. 8. (Left) Volcano plot showing the potential determining steps (PDSs) for the associative mechanism as a function of the free energy of adsorption of NNH on the surfaces of sulfides.

FIG. 9: Volcano plots showing all elementary reaction steps of electrochemical ammonia formation on metal sulfide surfaces plotted against the binding energy of *NNH for associative mechanism (top) and *N for the dissociative mechanism (bottom).

### DESCRIPTION

In the following, exemplary embodiments of the invention will be described, referring to the figures. These examples are provided to provide further understanding of the invention, without limiting its scope.

In the following description, a series of steps are described. The skilled person will appreciate that unless required by the context, the order of steps is not critical for the resulting configuration and its effect. Further, it will be apparent to the skilled person that irrespective of the order of steps, the presence or absence of time delay between steps, can be present between some or all of the described steps.

As used herein, including in the claims, singular forms of terms are to be construed as also including the plural form and vice versa, unless the context indicates otherwise.

Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

The present invention is based on the surprising discovery that on the surface of certain transition metal sulfide catalysts, it is possible to form ammonia at ambient temperature and pressure with a low applied potential. Given the importance of ammonia, not least in the production of fertilizer, and the energy intensive and environmentally unfavourable conditions that are typically used during its manufacture, the invention finds important applicability in various industries.

Thus, the invention provides processes and systems for generating ammonia at ambient temperature and pressure. In the process and system of the present invention, an electrolytic cell is used which can be any of a range of conventional commercially suitable and feasible electrolytic cell designs that can accommodate a special purpose cathode in accordance with the invention. Thus, the cell and system may in some embodiments have one or more cathode cells and one or more anode cells.

An electrolytic cell in the present context is an electrochemical cell that undergoes a redox reaction when electrical energy is applied to the cell.

The skilled person will appreciate that chemical compounds as described herein are provided by their chemical formula irrespective of their phase or state. In particular, compounds that are present in their gaseous state when present in a pure and isolated form at room temperature (such as N₂, H₂ and NH₃) are herein described by their chemical formula. For example, dinitrogen is herein described as N₂, whether present as nitrogen gas, as individual molecules, in clusters, bound to surfaces or present as solutes, and the same applies to other molecular species described herein.

The proton donor can be any suitable substance that is capable of donating protons in the electrolytic cell. The proton donor can for example be an acid, such as any suitable organic or inorganic acid. The proton donor can be provided in an acidic, neutral or alkaline aqueous solution. The proton donor can also, or alternatively, be provided by H₂ oxidation at the anode. I.e. hydrogen can be considered as a source of protons:

H₂⇔2(H⁺+e⁻). (2)

The electrolytic cell comprises at least three general parts or components, a cathode electrode, an anode electrode and an electrolyte. The overall cathode reaction can be presented as

N₂+6(H⁺+e⁻)⇔2NH₃ (3)

The catalyst surface can be hydrogenated by adding one hydrogen atom at a time, representing a proton from the solution and an electron from the electrode surface. The reaction mechanism can be shown in the equations 4-9 below describing the so-called associative mechanism, where an asterisk denotes a surface site:

*+N₂+6(H⁺+e⁻)⇔*NNH+5(H⁺+e−) (4)

*NNH+5(H⁺+e⁻)⇔*NNH₂+4(H⁺+e⁻) (5A)

*NNH+5(H⁺+e⁻)⇔*NHNH+4(H⁺+e⁻) (5B)

*NNH₂+4(H⁺+e⁻)⇔*N+NH₃(g)+3(H⁺+e⁻) (6Aa)

*NNH₂+4(H⁺+e⁻)⇔*NHNH₂+3(H⁺+e⁻) (6Ab)

*NHNH+4(H⁺+e⁻)⇔*NHNH₂+3(H⁺+e⁻) (6B)

*N+3(H⁺+e⁻)⇔*NH+2(H⁺+e⁻) (7A)

*NHNH₂+3(H⁺+e⁻)⇔*NH+NH_{3(g)}+2(H⁺+e⁻) (7Ba)

*NHNH₂+3(H⁺+e⁻)⇔*NH₂NH₂+2(H⁺+e⁻) (7Bb)

*NH+2(H⁺+e⁻)⇔*NH₂+(H⁺+e⁻) (8A)

*NH₂NH₂+2(H⁺+e⁻)⇔*NH₂+NH₃(g)+(H⁺+e⁻) (8Bb)

*NH₂+(H⁺+e⁻)⇔NH₃(g)+* (9)

For the dissociative mechanism the reaction mechanism is according to equations 10-16:

*+N₂+6(H⁺+e⁻)⇔2*N+6(H⁺+e−) (10)

2*N+6(H⁺+e⁻)⇔*N+*NH+5(H⁺+e−) (11)

*N+*NH+5(H⁺+e−)⇔*NH+*NH+4(H⁺+e−) (12A)

*N+*NH+5(H⁺+e−)⇔*N+*NH₂+4(H⁺+e−) (12B)

*NH+*NH+4(H⁺+e−)⇔*NH+*NH₂+3(H⁺+e−) (13A)

*N+*NH₂+4(H⁺+e−)⇔*N+NH_{3(g)}+3(H⁺+e−) (13B)

*NH+*NH₂+3(H⁺+e−)⇔*NH+NH_{3(g)}+2(H⁺+e−) (14Aa)

*NH+*NH₂+3(H⁺+e−)⇔*NH₂+*NH₂+2(H⁺+e−) (14Ab)

*N+3(H⁺+e−)⇔*NH+2(H⁺+e−) (14B)

*NH+2(H⁺+e−)⇔*NH₂+(H⁺+e−) (15Aa)

*NH₂+*NH₂+2(H⁺+e−)⇔*NH₂+NH_{3(g)}+(H⁺+e−) (15Ab)

*NH₂+(H⁺+e−)⇔*+NH_{3(g)} (16)

After the addition of 3(H⁺+e⁻) one ammonia molecule is formed and the second one is formed after the addition of 6(H⁺+e⁻).

The different parts or components can be provided in separate containers, or they can be provided in a single container. Thus, the anode and cathode can be placed in one and the same compartment of an electrolysis cell of the invention but in other embodiments the anode is in one compartment and the cathode is in another compartment. The electrolyte can be an aqueous solution in which ions are dissolved. The aqueous solution can be a neutral, an alkaline or an acidic solution. In some embodiments, the aqueous solution is an acidic solution. The electrolyte can also be a molten salt, for example a sodium chloride salt.

In general terms, the catalyst on the electrode surface should ideally have the following characteristics: It should (a) be chemically stable, it should (b) not become oxidized or otherwise consumed during the electrolytic process, it should facilitate the formation of ammonia, and (d) use of the catalyst should lead to the production of minimal amount of hydrogen gas. As will be further described, the sulfide catalysts according to the invention fulfil these characteristics.

AS further illustrated and discussed herein, the catalyst in the process and system of the invention comprises in some embodiments one or more transition metal sulfide selected from the group consisting of Yttrium sulfide, Scandium sulfide, Zirconium sulfide, Titanium sulfide, Vanadium sulfide, Chromium sulfide, Niobium sulfide, Nickel sulfide, Iron sulfide, Manganese sulfide, Cobalt sulfide, Iridium sulfide, Copper sulfide, Osmium sulfide, Ruthenium sulfide and Rhodium sulfide. Any mixtures and combinations of two or more of these are also applicable in the invention.

An advantage of the present invention is that the process can be suitably operated using aqueous electrolytes, such as preferably aqueous solutions with dissolved electrolytes (salts). Thus, in preferred embodiments of the process and system, the electrolytic cell comprises one or more aqueous electrolytic solutions, in one or more cell compartments. Aqueous electrolyte solutions may comprise any of various typical inorganic or organic salts such as but not limited to soluble salts of chloride, nitrate, chlorate bromide, etc. e.g. sodium chloride, potassium chloride, calcium chloride, ammonium chloride, and other suitable salts. The aqueous electrolyte solutions may also comprise any one, or a combination of, alkali or alkaline earth metal oxides, such as sodium hydroxide, potassium hydroxide, lithium hydroxide, calcium hydroxide, rubidium hydroxide and caesium hydroxide. The aqueous electrolyte solution can also further, or alternatively, comprise one or more organic or inorganic acids. Inorganic acids can include mineral acids that include but are not limited to, hydrochloric acid, nitric acid, phosphoric acid, sulfuric acid, boric acid, hydrofluoric acid, hydrobromic acid, and perchloric acid. The electrolyte can also comprise an organic solvent, preferably an organic solvent miscible in water that is mixed in an aqueous electrolyte.

As appears from herein, the essential feature of the present invention concerns the composition and structure of the cathode electrode. Transition metal sulfides have a wide variety of surface structures which affect the surface energy of these compounds and influence their chemical properties. The relative acidity and basicity of the atoms present on the surface of metal sulfides are also affected by the coordination of the metal cation and sulphur anion, which alter the catalytic properties of these compounds.

Depending on the substance composition of the catalyst, a suitable surface crystal structure may be preferred. Various different crystal structures exist for transition metal sulfides and different structures can be obtained at different growth conditions. It is within scope of the skilled person to select appropriate surface crystal structures.

In some embodiments the catalyst surface comprises at least one surface having a Rocksalt structure, a NiAs-type structure, or a Pyrite structure. The catalyst surface comprises in preferred embodiments at least one surface having a (100) facet or a (111) facet. Other crystal structure surfaces are as well encompassed within the scope of the invention (see., e.g., International Tables for Crystallography; http://it.iucr.org).

As described in more detail herein, running a current through the electrolytic cell leads to a chemical reaction in which nitrogen reacts with protons to form ammonia. The running of current is achieved by applying a voltage to the cell. The invention makes possible electrolytic production of ammonia at a low electrode potential, which is beneficial in terms of energy efficiency and equipment demands.

Without intending to be bound by theory, it is believed that the sulfide catalysts are capable of shifting the bottleneck of ammonia synthesis from N₂ cleavage to the subsequent formation of nitrogen-hydrogen species (*NH,*NH₂, or *NH₃) due to which simpler but yet higher rate of ammonia formation is anticipated.

In certain useful embodiments of the invention, ammonia can be formed at an electrode potential at less than about −1.1 V, such as less than about −1.0 V, less than about −0.9 V, less than about −0.8 V, less than about −0.7 V, less than about −0.6 V, less than about −0.5 V or less than about −0.4 V. In some embodiments, ammonia can be formed at electrode potential in the range of about −0.2 V to about −1.1 V, such as in the range of about −0.3 V to about −0.8 V, such as in the range of about −0.4 V to about −1.1 V, or in the range of about −0.5 V to about −1.01. The upper limit of the range can be about −0.6 V, about −0.7 V, about −0.8 V, about 1.0 V, or about −1.1 V. The lower limit of the range can be about −0.2 V, about −0.3 V, about −0.4 V, about −0.5 V or about −0.6 V.

An advantage of the present invention is the efficiency of NH₃ formation over H₂ formation, which has been a challenge in prior art investigations and trials. In certain embodiments of the invention, less than about 50% moles H₂ are formed compared to moles NH₃ formed, and preferably less than about 40% moles H_{z}, less than about 30% moles H₂, less than about 20% moles H₂, less than about 10% moles H₂, less than about 5% moles H₂, less than about 2% moles H₂, or less than about 1% moles H₂.

The system of the invention is suitably designed in order to accommodate one or more of the above process features. It is an advantage of the invention that the system can be made small, robust and cheaply, such as for using locally for production of fertilizer close to the intended site of use.

Ammonia can be used as such as fertilizer, by injecting into soil as gas, although this requires investment by farmers in pressurized storage tanks and injection machinery. Ammonia can also be used to form urea, typically by reacting with carbon dioxide. Ammonia can be reacted to form nitric acid, which in turn is readily reacted to form ammonium nitrate. Accordingly, systems and processes of the present invention can be readily combined with present solutions for reacting the produced ammonia to other desired products such as but not limited to the above mentioned.

NOₓ and SOₓ are generic terms for mono-nitrogen and mono-sulphur oxides, such as NO, NO₂, SO, SO₂ and SO₃. These gases are produced during combustion, especially at high temperatures. In areas of high motor vehicle traffic, the amount of these pollutants can be significant.

Accordingly, a useful aspect of the invention relates to a system for removing NOₓ and/or SOₓ from a stream of gas, by reacting the stream of gas with ammonia that is generated in situ in the stream, or in a system that can be fluidly connected to the stream of gas. The system can comprise a system for generating ammonia as described herein, in particular a system that comprises an electrolytic cell containing a transition metal sulfide catalyst as described herein. In this context, in situ should be understood as ammonia generation within the system, for example within the gas stream, or in a compartment within the system that is fluidly connected to the gas stream. The ammonia thus generated, when in contact with the stream of gas, will react with NOₓ and/or SOₓ in the stream of gas so as to convert these toxic species to other molecular species, such as N₂, H₂O and (NHₐ)₂SOₐIn some embodiments, the system can be for use in an automobile engine exhaust or in other engines, where ammonia can be generated in situ by a process according to the present invention, and which is then used to reduce SOₓ and/or NOₓ exhaust gases from the engine. Such system can suitably use electric current produced by conversion from the car engine. Thus, by using electric current from a car engine, ammonia can be generated in situ, and the generated ammonia can thus be allowed to react with SOₓ and/or NOₓ from the gas exhaust of the automobile. The ammonia can be generated in the automobile, and subsequently fed into the car exhaust. The ammonia can also be generated in situ within the automobile exhaust system. Thereby, NOₓ and/or SOₓ are removed from the car exhaust, reducing the amount of pollutants in the exhaust.

The invention will now be illustrated by the following non-limiting example that further describes particular advantages and embodiments of the present invention.

### EXAMPLES

### Example 1: DFT Calculations of 18 Transition Metal Sulfides

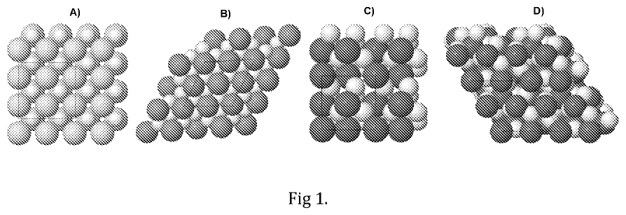

Interesting activity of TMSs have been mainly reported for oxygen depolarized cathode applications (3), hydrodesulfurization (4-6), H₂ evolution reaction (7-11), CO hydrogenation (12) and CO₂ reduction reaction (13,14), but there is no investigation reported in literature regarding the catalytic activity of these materials for electrochemical NRR to ammonia formation at ambient conditions. In this study, we looked at both the monosulfides and disulfides in some stable structures, the NiAs-type (Space Group=P63/mmc (194)), Rocksalt (Space Group=Fm3m (225)), and Pyrites (Space Group=Pa3 (205)). The NiAs-type is the most important crystal structure for the monosulfides assumed by a number of 3d monosulfides (VS, CrS, FeS, TiS, NiS, and NbS) (15,16). In the NiAs-type structure hexagonal packing involves octahedral sites with the strings of octahedral sites sharing common faces parallel to the c-axis. Each anion has then six nearest neighbour cations in a trigonal pyramid, and the interstitial positions are partly occupied in cation-rich compositions (See FIG. 1). Earlier monosulfides like ScS, YS, and ZrN are most stable in Rocksalt (NaCl) structure (15,17). The Pyrite structure is the dominant structure for the 3d (MnS₂, FeS₂, CoS₂ and NiS₂), 4d (RuS₂ and RhS₂), and 5d (OsS₂ and IrS₂) disulfides (16). Here we investigated the competition between adsorption of N₂H and H on the surface, and based on this information, we studied the catalytic properties of the sulfides that show higher probability of binding NNH rather than H when we explored the associative mechanism. We have studied the possibility of ammonia formation on these surfaces via dissociative mechanisms as well by looking into the adsorption free energies of 2*N (ΔG_{2*N}) on the surface and calculation of the activation energy for the N₂ dissociation where ΔG_{2*N} is exergonic. We also calculate the adsorption free energy of N and H on the clean surface of these sulfides to investigate the competition between nitrogen reduction to ammonia and hydrogen evolution reaction. Via both of the associative and dissociative mechanisms, we predicted the onset potentials needed for ammonia formation. Then we constructed the volcano plot with the use of the scaling relations between adsorption energy of the intermediates.

DFT Calculations:

We have considered 18 TMSs in this study and they are: YS, ScS, and ZrS in the Rocksalt (100) structure, TiS, VS, CrS, NbS, NiS, and FeS in NiAs-type (111) structure, and MnS₂, CoS₂, IrS₂, CuS₂, OsS₂, FeS₂, RuS₂, RhS₂, NiS₂ in Pyrite structure in both the (100) and (111) orientations. The monosulfide surfaces are modelled by 32 atoms in four layers, each layer consisting of 4 metal atoms and 4 sulphur atoms. The disulfides are modelled by 48 atoms in four layers, each layer consisting of 4 metal atoms and 8 sulphur atoms (See FIG. 1). The bottom two layers are kept fixed whereas the upper two layers and the adsorbed species are allowed to fully relax. Boundary conditions are periodic in the x and y directions and the surfaces are separated by 14 A⁺ of vacuum in the z direction. The structural optimization is considered converged when the forces in any direction on all mobile atoms are less than 0.01 eV/A⁺. The RPBE lattice constants were optimized for each sulfide and spin-polarization was accounted.

All the calculations are performed with Density functional theory (DFT) using the RPBE exchange correlation functional (18). A plane wave basis set with an energy cutoff of 350 eV is used to represent the valence electrons with a PAW (19) representation of the core electrons as implemented in the Vienna Ab initio Simulation Package (VASP) code (20-27). The self-consistent electron density is determined by iterative diagonalization of the KohnSham Hamiltonian, with the occupation of the KohnSham states being smeared according to a FermiDirac distribution with a smearing parameter of kBT=0.1 eV. A 4×4×1 MonkhorstPack k-point sampling is used for all the surfaces.

FIG. 1 shows metal sulfide unit cell and top views of the low-index surfaces used in this study: (A) Rocksalt (100), (B) NiAs-type (111), (C) Pyrite (100), and (D) Pyrite (111). The surface unit cells have been repeated once in the lateral directions. Sulfur atoms are represented by yellow spheres and metal atoms by light grey, dark grey or green spheres.

Nitrogen Electrochemical Reactions. The required protons for the reaction could be either supplied through H₂ oxidation reaction or water splitting at the anode. In order to link our absolute potential to the SHE, we refer to H₂ here only as a convenient source of protons and electrons (28),

H₂⇔2(H⁺+e⁻) (2)

where the protons are solvated in the electrolyte. The overall reaction for N₂ reduction is

N₂+6(H⁺+e⁻)⇔2NH₃ (3)

The surface is hydrogenated by adding one hydrogen atom at a time, representing a proton from the solution and an electron from the electrode surface. The associative mechanism studied here is based on the equations 4-9 as shown above in the Description section.

For the dissociative mechanism, the reaction mechanism is according to equations 10-16 shown above.

Based on the favourable reaction pathway, the first NH₃ molecule is produced after three or four protons added to the surface. The second NH₃ molecule is however produced after the addition of six protons in total. The free adsorption energy of NNH is then compared with that of H to explore whether the surface is more selective toward NH₃ formation or H₂ evolution. The free energy of NNH adsorption is compared to that of proton adsorption to investigate whether the surface is more selective toward ammonia formation or hydrogen evolution. The free energy of each elementary step is estimated at T=298 K according to:

ΔG=ΔE+ΔE(ZPE)−TΔS (17)

where ΔE is the energy calculated using DFT. ΔE(ZPE) and ΔS are the differences in zero-point energy and entropy, respectively, between the adsorbed species and the gas phase molecules. They are calculated within a harmonic approximation and the values are given in Table 1. For all the electrochemical reaction steps, the effect of an applied bias, U, is included for all electrochemical reaction steps by shifting the free energy for a reaction involving n electrons by −neU using the computational hydrogen electrode (CHE) (28) so the free energy of each elementary step is given by:

ΔG=ΔE+ΔE(ZPE)TΔS−neU (18)

at pH=0. Explicit inclusion of water (29,30) in the simulations would significantly increase the computational effort required and is thus not included in the present study. However, the presence of water is known to stabilize some species via hydrogen bonding (31). For example, *NH₂ is anticipated to be slightly more stable in the vicinity of water but *N will not be affected by the water layer. Previous studies have appraised the stabilization effects of water to be smaller than 0.1 eV per hydrogen bond (32). Consequently, inclusion of hydrogen bonding is estimated to change the onset potentials reported here by less than 0.1 eV, a correction that has not been included here.

Result and Discussion

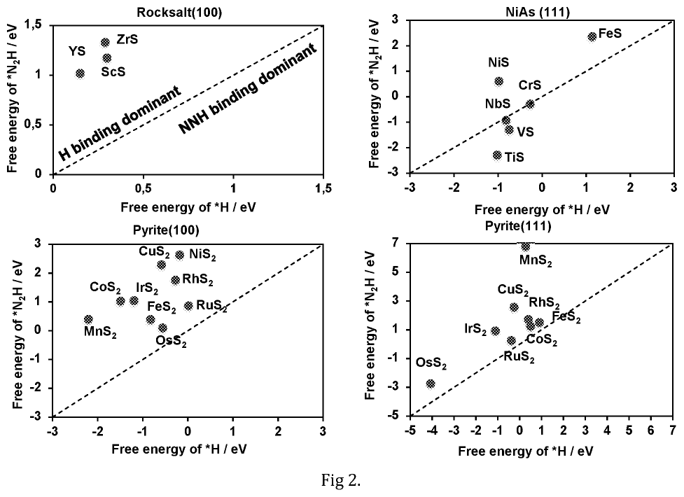

Catalytic Activity. Considering the associative mechanism similar to how nitrogenase synthesizes ammonia, hydrogenation of N₂ molecule takes place on the surface before it splits, while in dissociative mechanism N₂ molecule first splits on the surface and then hydrogenation initiates. In order to find a sulfide surface that is more efficient for ammonia formation rather than the competing hydrogen evolution, we have calculated and then compared the adsorption energy of NNH with hydrogen adsorption on the surface. Both the NNH and the hydrogen atom were allowed to find their most favourable binding site on the surface. This is done for both the mono- and disulfide surfaces prior to investigation of the catalytic activity and exploration of the reaction pathway. FIG. 2 represents the outcome of this analysis with the dashed line specifies where these free energies become equal. The sulfides located under the line should begin the NRR without being poisoned by protons. While those above the dashed line are assumed to lead to H₂ formation.

In FIG. 2 the adsorption free energy of NNH is compared to that of H on the surface of sulfides. The dashed line indicates where these free energies are equal. The sulfides below the dashed line are able to begin the ammonia formation reaction without being poisoned by protons.

The adsorption of NNH is favourable only on the sulfides of NiAs-type structure and should therefore be interesting for electrochemical ammonia formation at higher yields. FeS₂, CoS₂, and RuS₂ in Pyrite (111) have a similar binding free energy of NNH and H and worth further investigations for ammonia formation. However, they might contribute some of the applied electricity to the formation of hydrogen in the experiment, and both ammonia and hydrogen gas can be predicted on these three surfaces. We should point this out here that they are merely the first steps toward NRR and HER on these surfaces, and accordingly the influence of inclusion of water layers and calculation of the activation energies of the protonation processes should be investigated in future for a more comprehensive insight on this process.

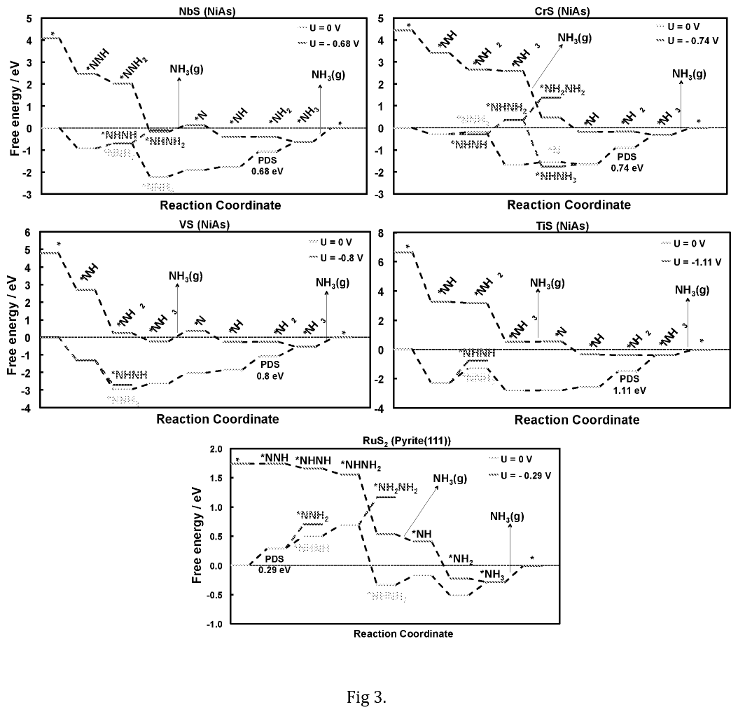

Associative mechanism. The catalytic activity of TiS, VS, NbS, and CrS in the NiAs-type as well as FeS₂, CoS₂, and RuS₂ in Pyrite (111) is calculated by DFT toward electrochemical ammonia formation with consideration of the associative mechanism depicted in equations 4-9. For each sulfide the free energy landscape is constructed by calculating the free energy using eq. 17 of each intermediate from N₂ to NH₃, with reference to N₂ and H₂ in the gas phase. The free energy corrections used are shown in Table 1. For CoS₂ and FeS₂ in the pyrite structure, further protonation of the surface caused surface distortion of these sulfides and thus are eliminated from further analyses due to instability. FIG. 3 shows the free energy landscape of ammonia formation on these sulfides, where the corresponding potential-determining step (PDS) is also reported for each surface. That step determines the onset potential required for all reaction steps to become downhill in free energy (28). This step is identified as a measure of the activity toward ammonia formation.

TABLE 1
The zero-point energy and entropy corrections
for NiAs-type and pyrite (111) structures.

| | | | | | |
|---|---|---|---|---|---|
| NiAS | TS | ZPE | Pyrite | TS | ZPE |

| | | | | |
|---|---|---|---|---|
| *H | 0.006 | 0.168 | 0.008 | 0.172 |
| *NNH | 0.087 | 0.488 | 0.109 | 0.493 |
| *NNH₂ | 0.102 | 0.772 | 0.099 | 0.828 |
| *NNH₃ | 0.170 | 1.006 | 0.204 | 1.080 |
| *NHNH | 0.092 | 0.735 | 0.112 | 0.798 |
| *NHNH₂ | 0.117 | 1.032 | 0.119 | 1.145 |
| *NH₂NH₂ | 0.161 | 1.298 | 0.155 | 1.377 |
| *NHNH₃ | 0.228 | 1.379 | 0.227 | 1.379 |
| *NH | 0.048 | 0.367 | 0.054 | 0.356 |
| *NH₂ | 0.079 | 0.651 | 0.083 | 0.665 |
| *NH₃ | 0.161 | 0.991 | 0.152 | 0.979 |
| *N | 0.029 | 0.09 | 0.07 | 0.078 |
| NH₃ | 0.74 | 0.89 | 0.74 | 0.89 |
| N₂ | 0.6 | 0.15 | 0.6 | 0.15 |
| H₂ | 0.41 | 0.27 | 0.41 | 0.27 |

As can be seen, the PDS for all the NiAs-type surfaces is formation of the NH₂ intermediate after the first ammonia molecule has been formed. But for the RuS₂ of Pyrite structure, the PDS is formation of NNH at the beginning of the pathway. However, that step is always an exergonic step on the sulfides of the NiAs-type structure. Interestingly, it was found that RuS₂ is the most active sulfide with an overpotential of only 0.29 V. Although this sulfide can contribute to formation of hydrogen as well and thus lower the yield of ammonia formation in experiments, this should not diminish the importance of RuS₂ for further experimental investigations. This sulfide can, for example, be tested experimentally with the use of non-aqueous electrolytes like 2,6-lutidinium (LutH⁺) (33) or titanocene dichloride ((η⁵-C₅H₅)₂TiCl₂) (34) to attenuate HER. Another interesting observation is that on all the NiAs-type structures as well as the Pyrite RuS₂, the step associated with the *NNH₃ formation does thermodynamically lead to dissociation of the N—N bond and formation of *N and *NH₃. Thus, dinitrogen dissociation should be relatively facile on these sulfide surfaces. VS is the only candidate on the surface of which, *NNH₂ is split to *N and *NH₂.

FIG. 3 shows free energy diagrams for ammonia formation on the surface of TMSs via the associative mechanism. The potential determining step (PDS) for the NiAs-type structure is the fifth protonation step and formation of NH₂ after formation of the first ammonia molecule whereas the PDS for the Pyrite RuS₂ surface is the first protonation step, NNH. The reaction steps are referenced to the clean surface and N₂ and H₂ in the gas phase. The blue line is always representative of the pathway via *NHNH species, and the purple via *NH₂NH₂ species following the *NHNH₂ species.

Dissociative mechanism. In this mechanism, the dissociation of nitrogen molecule is a crucial reaction step. Therefore, the binding energy of adsorption of two nitrogen atoms on the surface of TMSs was initially calculated according to:

ΔE=E_{(clean+2*N)}−E_{(clean)}−E_{(N2(g))} (19)

where E_{(clean+2*N)} is the total energy of the TMS with two N adatoms adsorbed on the surface, E_{(clean)} is the total energy of the TMS surface when there is no adsorbate, and E_{(N2(g))} is the total energy of nitrogen molecule in a box. AE is then the binding energy of two N adatoms on the clean surface of TMS. To obtain the free energy of adsorption of two N adatoms on the surface a constant shift of 0.6 eV was applied to account for the loss of entropy of N₂(g) (35), (ΔG=ΔE+0.6). If ΔG≤0 eV, the dissociation di-nitrogen on the surface should be exergonic and the activation energy needs to be calculated. If ΔG>0 eV, dissociation of dinitrogen is endergonic and as it gets more endergonic, it becomes thermodynamically and kinetically more difficult to surmount at ambient conditions. This analysis was done for all the TMSs studied here and the result is shown in table 2 below. As indicated in this table, for some of these surfaces the adsorption of 2N causes surface atoms distortion. So, these surfaces were considered unstable and not investigated further for dissociative mechanism.

TABLE 2
Activation energy (Ea [eV]) and reaction free energy (ΔG, [eV])
of N₂ dissociation on the clean surfaces of TMSs.

| Rocksalt | ΔG₂*_{N} | NiAs | ΔG₂*_{N} | Ea | | ΔG₂*_{N} | |
|---|---|---|---|---|---|---|---|
| (100) | (eV) | (111) | (eV) | (eV) | Pyrite | (eV) | |
| ScS | 1.87 | TiS | −5.33 | 0.59 | | (100) | (111) |
| YS | 1.81 | VS | −3.97 | 0.40 | MnS₂ | 3.72 | 5.66 |
| ZrS | unstable | NbS | −4.29 | 0.00 | FeS₂ | 1.99 | 2.92 |
| | | CrS | −2.83 | 0.02 | CoS₂ | 4.76 | 5.76 |
| | | NiS | 2.63 | — | NiS₂ | 3.17 | 6.92 |
| | | FeS | 2.87 | — | CuS₂ | 0.3 | 4.21 |
| | | | | | RuS₂ | 2.37 | 0.88 |
| | | | | | RhS₂ | 6.34 | 4.90 |
| | | | | | OsS₂ | unstable | unstable |
| | | | | | IrS₂ | 3.71 | 4.13 |

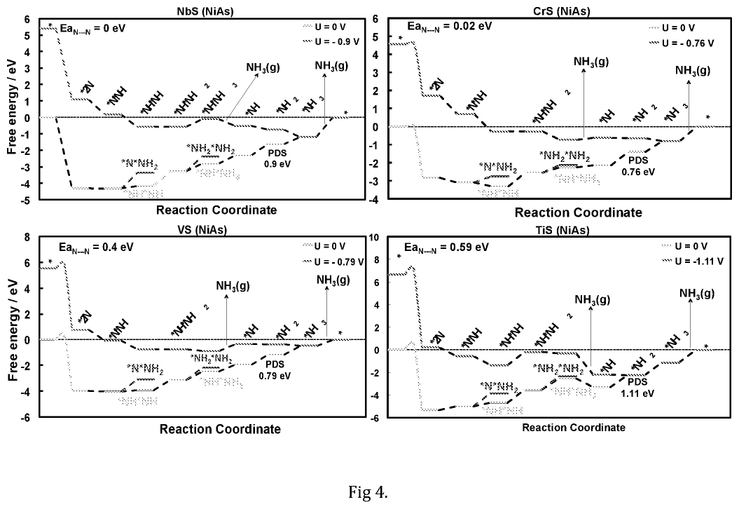

For most of the other sulfides, the reaction free energy of N₂ splitting is endergonic and the energy barrier would be correspondingly high and that step could not be facilitated at room temperature. This makes the dissociative mechanism unlikely to occur at ambient conditions on these surfaces. However, there are four candidates where the adsorption of 2N* is highly exergonic on the surface; TiS, VS, CrS, and NbS in NiAs-type structure. Interestingly, these are the same sulfides as predicted to be promising via the associative mechanism in FIG. 3. Therefore, the activation energy of N₂ splitting on the surface is calculated with the use of the climbing image nudged elastic band (CI-NEB) (36) and included in Table 2. The barriers on TiS and VS are relatively low, 0.59 and 0.40 eV, respectively, and would result in moderate rates at ambient conditions. However, there are no barriers on CrS and NbS (0.02 and 0.00, respectively), and the dissociation would be highly facile on those surfaces. The pathway towards ammonia formation via this mechanism is also explored on these sulfides via equations 10-16. FIG. 4 shows the free energy diagrams for NRR to ammonia where the activation energies of dinitrogen dissociation (Ea_{N . . . N}) are included.

In the shown diagrams, the potential determining step (PDS) for all of these sulfides is the fifth protonation step and formation of *NH₂ intermediate after release of the first ammonia molecule. The reaction steps are referenced to the clean surface and N₂ and H₂ in the gas phase. The blue line is always representative of the pathway via *N*NH₂ species, and the purple via *NH₂*NH₂ species following the *NHNH₂. As shown, the most favourable pathway is ammonia formation via *NH*NH, the green line.

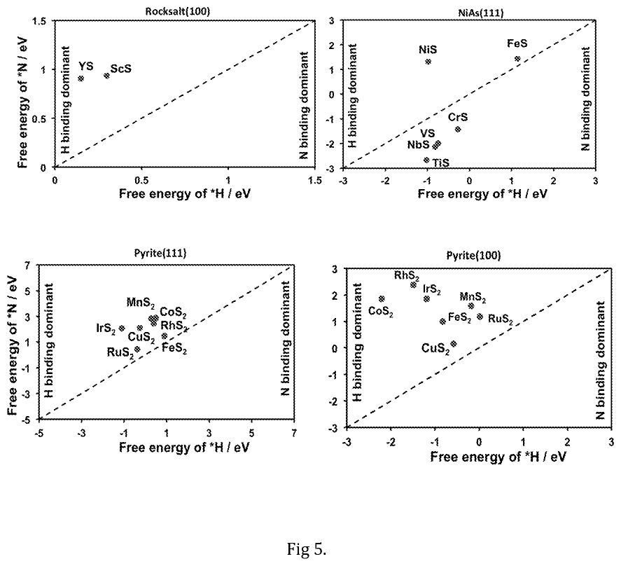

The most active sulfide that can catalyze ammonia formation via the dissociative mechanism is CrS with the predicted onset potential of around −0.76 V vs. RHE and with an activation energy of dinitrogen dissociation of only 0.02 eV. NbS can also be an interesting candidate on the surface of which facile dissociation of N₂ can occur and the onset potential is calculated to be 0.9 V vs. RHE. For VS and TiS the non-electrochemical N₂ dissociation step is predicted to proceed at slower rate at ambient conditions, and the reaction is predicted to occur at 0.79 and 1.22 V vs. RHE, respectively. For these sulfides the PDS is *NH₂ formation which is the most endergonic step along the path. In addition, the competition between adsorption of N and H on the surface of these sulfides is investigated in order to find a sulfide surface that is more efficient for ammonia formation rather than the competing hydrogen evolution. This analysis is done for all the sulfides and the result shown in FIG. 5. According to this analysis, only NiAs-type structures of VS, CrS, NbS, and TiS favor adsorption of N on the surface rather than H, while the rest favor H adsorption and thus can yield to higher hydrogen evolution.

FIG. 5 shows a comparison of the free energy of adsorption of N to that of H on the clean surface of sulfides for the dissociative mechanism. The dashed line denotes where these free energies are equal. The sulfides below the dashed line are able to bind N more favourably than H and thus expected to be more efficient for ammonia formation.

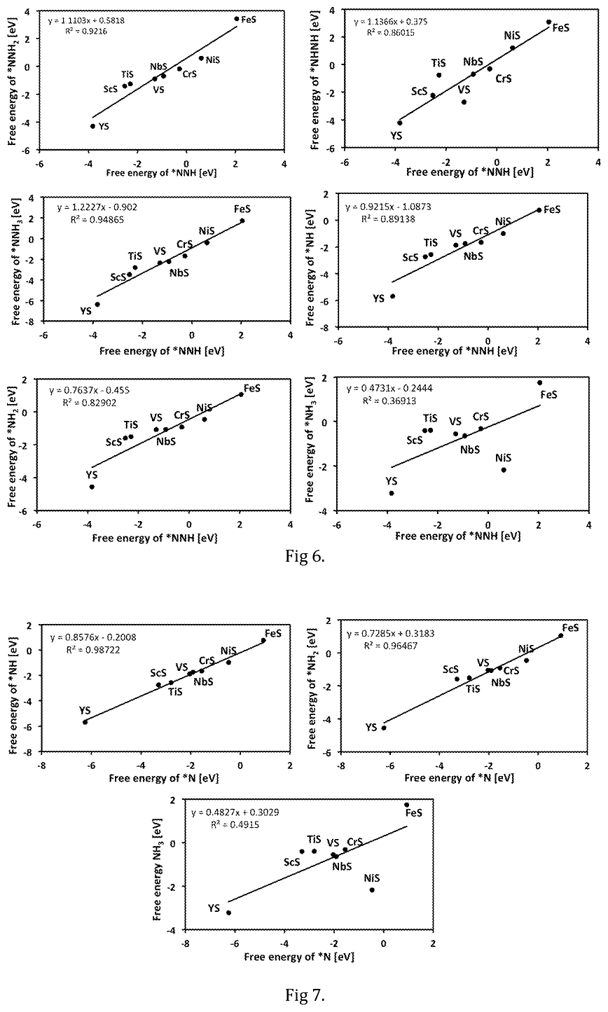

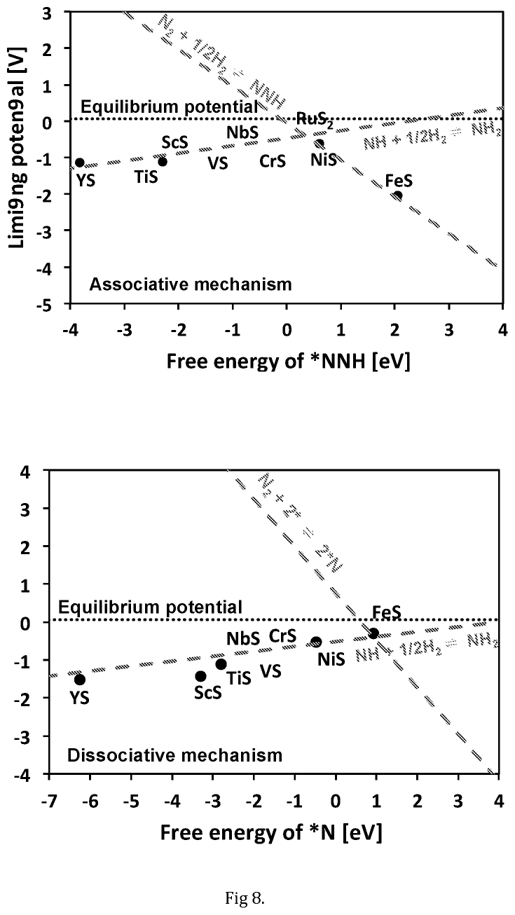

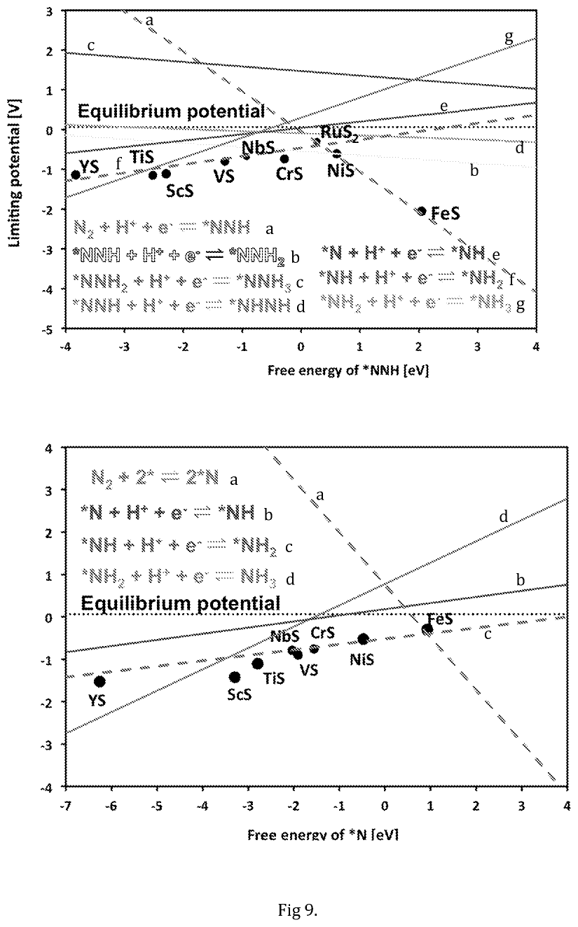

Construction of volcano plots. In order to construct volcano plots for both associative and dissociative mechanisms, binding energies of various intermediates of the N₂ reduction mechanism was found to scale well with adsorption free energy of NNH (for associative mechanism) and N (for dissociative mechanism). The scaling relations are shown in FIGS. 6 and 7, and the volcano plots are illustrated in FIG. 8. Here, only the PDSs are shown but in FIG. 9 all elementary steps are shown.

FIGS. 6 and 7 show scaling relations between the free energy of the intermediates as a function of the free energy of *NNH as descriptor for the associative mechanism, and of *N, respectively.

FIG. 8 (Left) is a volcano plot showing the potential determining steps (PDSs) for the associative mechanism as a function of the free energy of adsorption of NNH on the surfaces of NiAs-type sulfides (except RuS₂ which is in the pyrite structure and added to the volcano as a single point). Lines are constructed from scaling relations (see FIG. 6) but explicit data points are included for the PDSs. Although YS and ScS are more stable in rocksalt structure, we have included them here in the NiAs structure in order to get better scaling relations for the construction of the volcano plots. FeS and NiS are also included here for the same reason but they are predicted to evolve H₂ rather than NH₃ according to FIG. 2. (Right) Volcano plot showing the PDSs for the dissociative mechanism as a function of the free energy of adsorption of N. Lines are constructed from scaling relations (see FIG. 7) but explicit data points are included for the PDSs. The FeS and NiS that are located on top of the dissociative volcano are not very promising as they are predicted (according to FIG. 5) to bind H more favourably than N and thus expected to mainly form H₂ rather than NH₃.

FIG. 9 shows volcano plots of all elementary reaction steps of electrochemical ammonia formation on metal sulfide surfaces plotted against the binding energy of *NNH for associative mechanism (top) and *N for the dissociative mechanism (bottom). The lines are calculated using the scaling relations depicted in FIGS. 6 and 7.

NiS and FeS in NiAs-type structure are also included for this analysis despite the dominancy of H adsorption over NNH on their surfaces. ScS and YS are also included in NiAs-type structure in order to get a better descriptive volcano. The best descriptor found for these sulfides is the free energy of adsorption of NNH for the associative mechanism and the free energy of adsorption of N for the dissociative mechanism. For the associative mechanism, the PDS is formation of NNH intermediate for the candidates lying on the right leg of the volcano but reduction of NH to NH₂ for the ones on the left leg. Considering only the candidates which are most stable in the NiAs structure and predicted to be prone towards NRR rather than HER (see FIG. 2), CrS, NbS, VS and TiS are predicted to be promising candidates for NRR to ammonia through the associative mechanism. For RuS₂ (included here in its pyrite structure with the (111) surface) the PDS is formation on NNH and as can be seen, it is located on top of the associative volcano being the most promising candidate here. However, RuS₂ is also expected to contribute to some hydrogen evolution that can decrease the yield of ammonia if used in aqueous electrolytes. However, using non-aqueous electrolytes like 2,6-lutidinium (LutH⁺) (33) or titanocene dichloride ((η⁵-C₅H₅)₂TiCl₂) (34) might attenuate HER, and thus not affect the yield of ammonia considerably. For the dissociative mechanism, the PDS for all these sulfides is reduction of NH to NH₂ lying on the green line in the volcano. Even though FeS is located on top of the dissociative volcano plot, it might not be the most promising candidate here as, first of all it is predicted to get poisoned by proton and thus contribute to hydrogen evolution (according to FIG. 5), and second of all the N₂ dissociation on FeS was found to be a huge endergonic step (with the free energy of 2.87 eV according to table 2). This holds true for NiS as well. Therefore, FeS and NiS become less interesting in aqueous media compared to other candidates, which are a bit further down from the top of the volcano. However, CrS, NbS, VS and TiS are all predicted promising candidates here that also bind N more favourably than H (see FIG. 5). All these candidates have an exergonic N₂ dissociation step. CrS and NbS have negligible energy barriers for N₂ dissociation, while those barriers are higher on VS and TiS but should be surmountable at ambient conditions (see Table 2 and FIG. 4). Therefore, via the dissociative mechanism, VS, CrS, NbS, and TiS are predicted to be more selective towards NRR than HER, while FeS and NiS are expected to be more selective towards HER (see FIG. 5).

### CONCLUSION

In order to explore the catalytic capability of a range of different transition metal mono- and disulfide surfaces for electrochemical ammonia synthesis at ambient conditions, DFT calculations were used to investigate the energetics of the intermediates along the reaction path and construct free energy diagrams and volcano plots. This is the first report on the possibility of catalysing electrochemical ammonia formation on the surfaces of transition metal sulfides. For the sulfides that are expected to adsorb NNH rather than H on the surface and therefore assumed to be more selective for N₂ reduction than H₂ formation, the catalytic activity was investigated and the potential determining step and the overpotential predicted via the associative mechanisms. The dissociative mechanism was also investigated on the sulfide surfaces that bind N more favourably than H and also entail an exergonic N₂ dissociation step. From the scaling relation plots, volcano plots are constructed for both mechanisms where RuS₂ is predicted to have low overpotential towards electrochemical ammonia formation via associative mechanism, or 0.3 V. The other promising candidates from this study, CrS, NbS, VS, and TiS, can reduce nitrogen to ammonia via either mechanism with overpotentials around 0.7-1.1 V.

### REFERENCES

(1) Song Y., Johnson D., Peng R., Hensley D. K., Bonnesen P. V., Liang L., Huang J., Yang F., Zhang F., Qiao R., Baddorf A. P., Tschaplinski, T. J., Engle N. L., Hatzell M. C., Wu, Z., Cullen, D. A., Meyer, H. M., Sumpter, B. G., Rondinone, A. J., A physical catalyst for the electrolysis of nitrogen to ammonia, Science Advances, 2018, 10.1126/sciadv.1700336
(2) Zhou, F. Azofra, L. M., Ali, M., Kar, M., Simonov, A., N., McDonnell-Worth, C., Sun, C., Zhanga, X., MacFarlane, D., R., Electro-synthesis of ammonia from nitrogen at ambient temperature and pressure in ionic liquids. Energ. Environ. Sci. 2017, 10, 2516-2520.

(3) Zhang, L.; Mallikarjun Sharada, S.; Singh, A. R.; Rohr, B. A.; Su, Y.; Qiao, L.; Nørskov, J. K. A Theoretical Study of the Effect of a Non-Aqueous Proton Donor on Electrochemical Ammonia Synthesis. Phys. Chem. Chem. Phys. 2018.
(4) Jeong, E. Y.; Yoo, C. Y.; Jung, C. H.; Park, J. H.; Park, Y. C.; Kim, J. N.; Oh, S. G.; Woo, Y.; Yoon, H. C. Electrochemical Ammonia Synthesis Mediated by Titanocene Dichloride in Aqueous Electrolytes under Ambient Conditions. ACS Sustain. Chem. Eng. 2017, 5 (11), 9662-9666.
(5) Gullá, A. F.; Gancs, L.; Allen, R. J.; Mukerjee, S. Carbon-Supported Low-Loading Rhodium Sulfide Electrocatalysts for Oxygen Depolarized Cathode Applications. Appl. Catal. A Gen. 2007, 326 (2), 227-235.
(6) HARRIS, S. Catalysis by Transition Metal Sulfides: The Relation between Calculated Electronic Trends and HDS Activity. J. Catal. 1984, 86 (2), 400-412.
(7) Topsøe, H.; Clausen, B. S. Active Sites and Support Effects in Hydrodesulfurization Catalysts. Appl. Catal. 1986, 25 (1-2), 273-293.
(8) Hensen, E. J. M.; Brans, H. J. A.; Lardinois, G. M. H. J.; de Beer, V. H. J.; van Veen, J. A. R.; van Santen, R. A. Periodic Trends in Hydrotreating Catalysis: Thiophene Hydrodesulfurization over Carbon-Supported 4d Transition Metal Sulfides. J. Catal. 2000, 192 (1), 98-107.
(9)Šarić, M.; Rossmeisl, J.; Moses, P. G. Modeling the Adsorption of Sulfur Containing Molecules and Their Hydrodesulfurization Intermediates on the Co-Promoted MoS2 Catalyst by DFT. J. Catal. 2018, 358, 131-140.
(10) Jaramillo, T. F.; Jorgensen, K. P.; Bonde, J.; Nielsen, J. H.; Horch, S.; Chorkendorff, I. Identification of Active Edge Sites for Electrochemical H2 Evolution from MoS2 Nanocatalysts. Science 2007, 317 (5834), 100-102.
(11) Bonde, J.; Moses, P. G.; Jaramillo, T. F.; Nørskov, J. K.; Chorkendorff, I. Hydrogen Evolution on Nano-Particulate Transition Metal Sulfides. Faraday Discuss. 2009, 140, 219-231.
(12) Kibsgaard, J.; Chen, Z.; Reinecke, B. N.; Jaramillo, T. F. Engineering the Surface Structure of MoS2 to Preferentially Expose Active Edge Sites for Electrocatalysis. Nat. Mater. 2012, 11 (11), 963-969.
(13) Benck, J. D.; Hellstern, T. R.; Kibsgaard, J.; Chakthranont, P.; Jaramillo, T. F. Catalyzing the Hydrogen Evolution Reaction (HER) with Molybdenum Sulfide Nanomaterials. ACS Catal. 2014, 4 (11), 3957-3971.
(14) Ivanovskaya, A.; Singh, N.; Liu, R. F.; Kreutzer, H.; Baltrusaitis, J.; Van Nguyen, T.; Metiu, H.; McFarland, E. Transition Metal Sulfide Hydrogen Evolution Catalysts for Hydrobromic Acid Electrolysis. Langmuir 2013, 29 (1), 480-492.
(16) Shi, X.-R.; Jiao, H.; Hermann, K.; Wang, J. CO Hydrogenation Reaction on Sulfided Molybdenum Catalysts. J. Mol. Catal. A Chem. 2009, 312 (1-2), 7-17.
(17) Chan, K.; Tsai, C.; Hansen, H. A.; Nørskov, J. K. Molybdenum Sulfides and Selenides as Possible Electrocatalysts for CO₂ Reduction. ChemCatChem 2014, 6 (7), 1899-1905.
(18) Asadi, M.; Kumar, B.; Behranginia, A.; Rosen, B. A.; Baskin, A.; Repnin, N.; Pisasale, D.; Phillips, P.; Zhu, W.; Haasch, R.; et al. Robust Carbon Dioxide Reduction on Molybdenum Disulfide Edges. Nat. Commun. 2014, 5, 1-8.
(19) Rao, C. N. R.; Pisharody, K. P. R. Transition Metal Sulfides. Prog. Solid State Chem. 1976, 10, 207-270.
(20) Raybaud, P.; Kresse, G.; Hafner, J.; Toulhoat, H. Ab Initio Density Functional Studies of Transition-Metal Sulfides: I. Crystal Structure and Cohesive Properties. J. Phys. Condens. Matter 1997, 9 (50), 11085-11106.
(21) Jain, A.; Ong, S. P.; Hautier, G.; Chen, W.; Richards, W. D.; Dacek, S.; Cholia, S.; Gunter, D.; Skinner, D.; Ceder, G.; et al. The Materials Project: A Materials Genome Approach to Accelerating Materials Innovation. APL Mater. 2013, 1 (1), 11002.
(22) Hammer, B.; Hansen, L.; Nørskov, J. Improved Adsorption Energetics within Density-Functional Theory Using Revised Perdew-Burke-Ernzerhof Functionals. Phys. Rev. B 1999, 59 (11), 7413-7421.
(23) Blöchl, P. Projector Augmented-Wave Method. Phys. Rev. B 1994, 50 (24), 17953-17979.
(24) Kresse, G.; Hafner, J. Ab. Initio Molecular Dynamics for Liquid Metals. Phys. Rev. B 1993, 47 (1), 558-561.
(25) Kresse, G.; Hafner, J. Ab Initio Molecular-Dynamics Simulation of the Liquid-Metal-amorphous-Semiconductor Transition in Germanium. Phys. Rev. B 1994, 49 (20), 14251-14269.
(26) Kresse, G.; Furthmüller, J. Efficiency of Ab-Initio Total Energy Calculations for Metals and Semiconductors Using a Plane-Wave Basis Set. Comput. Mater. Sci. 1996, 6, 15-50.
(27) Kresse, G.; Furthmüller, J. Efficient Iterative Schemes for Ab Initio Total-Energy Calculations Using a Plane-Wave Basis Set. Phys. Rev. B. Condens. Matter 1996, 54 (16), 11169-11186.
(28) Nørskov, J. K.; Rossmeisl, J.; Logadottir, A.; Lindqvist, L.; Kitchin, J. R.; Bligaard, T.; Jónsson, H. Origin of the Overpotential for Oxygen Reduction at a Fuel-Cell Cathode. J. Phys. Chem. B 2004, 108 (46), 17886-17892.
(29) Hussain, J.; Jónsson, H.; Skúlason, E. Faraday Efficiency and Mechanism of Electrochemical Surface Reactions: CO2 Reduction and H2 Formation on Pt(111). Faraday Discuss. 2016, 195, 619-636.
(30) J. Hussain, H. Jónsson, E. Skúlason, Calculations of Product Selectivity in Electrochemical CO2 Reduction, ACS Catalysis 2018, 8, 5240-5249.
(31) Tripković, V.; Skúlason, E.; Siahrostami, S.; Nørskov, J. K.; Rossmeisl, J. The Oxygen Reduction Reaction Mechanism on Pt(111) from Density Functional Theory Calculations. Electrochim. Acta 2010, 55 (27), 7975-7981.
(32) E. Skúlason, T. Bligaard, S. Gudmundsdóttir, F. Studt, J. Rossmeisl, F. Abild-Pedersen, T. Vegge, H. Jónsson, J. K. Nørskov, A theoretical evaluation of possible transition metal electro-catalysts for N2 reduction. Phys. Chem. Chem. Phys. 2012, 14, 1235-1245.
(33) L. Zhang, S. Mallikarjun Sharada, A. R. Singh, B. A. Rohr, Y. Su, L. Qiao, J. K. Nørskov, A theoretical study of the effect of a non-aqueous proton donor on electrochemical ammonia synthesis. Phys. Chem. Chem. Phys. 2018, 20, 4982-4989.
(34) E. Y. Jeong, C. Y. Yoo, C. H. Jung, J. H. Park, Y. C. Park, J. N. Kim, S. G. Oh, Y. Woo, H. C. Yoon, Electrochemical ammonia synthesis mediated by titanocene dichloride in aqueous electrolytes under ambient conditions. ACS Sustain. Chem. Eng. 2017, 5, 9662-9666.
(35) Lide, D. R. CRC Handbook of Chemistry and Physic, 78th ed.; Lide, D. R., Ed.; Florida, 1997.
(36) Henkelman, G.; Uberuaga, B. P.; Jónsson, H. A Climbing Image Nudged Elastic Band Method for Finding Saddle Points and Minimum Energy Paths. J. Chem. Phys. 2000, 113 (22), 9901-9904.

1. A process for producing ammonia comprising:
feeding N₂ to an electrolytic cell that comprises a cathode, an anode, an electrolyte and at least one source of protons;
allowing the N₂ to come into contact with an electrode surface of the cathode in the electrolytic cell, wherein said electrode surface comprises a catalyst surface comprising at least one transition metal sulfide; and
running a current through said electrolytic cell, whereby nitrogen reacts with protons to form ammonia.

2. The process of claim 1, wherein the catalyst comprises one or more transition metal sulfide selected from the group consisting of Yttrium sulfide, Scandium sulfide, Zirconium sulfide, Titanium sulfide, Vanadium sulfide, Chromium sulfide, Niobium sulfide, Nickel sulfide, Iron sulfide, Manganese sulfide, Cobalt sulfide, Iridium sulfide, Copper sulfide, Osmium sulfide, Ruthenium sulfide and Rhodium sulfide.

3. The process of claim 1, wherein the catalyst surface comprises at least one surface having a Rocksalt structure, a NiAs-type structure, or a Pyrite structure.

4. The process of claim 1, wherein the catalyst surface comprises at least one surface having a (100) facet or a (111) facet.

5. The process of claim 1, wherein ammonia is formed in the electrolytic cell at an electrode potential at less than about −1.2 V, using a reversible hydrogen electrode (RHE) as a reference.

6. The process of claim 1, wherein less than 50% moles H₂ are formed compared to moles NH₃ formed.

7. The process of claim 1, wherein said electrolytic cell comprises one or more electrolytic solution which is preferably an aqueous electrolytic solution.

8. The process of claim 7, wherein the electrolytic cell comprises a liquid electrolyte selected from the group consisting of an aqueous electrolytic solution and an electrolyte comprising an organic solvent.

9. The process of claim 1, wherein the source of protons in the formation of ammonia is from water splitting at the anode or H₂ oxidation reaction in the anode.

10. The process of claim 1, wherein the electrolytic cell comprises an anode within one cell compartment and a cathode within another cell compartment.

11. The process of claim 1, wherein the process is carried out at a temperature in the range from about 0° C. to about 50° C.

12. The process of claim 1, wherein the process is carried out at atmospheric pressure.

13. The process of claim 1, wherein the process is carried out at a pressure in the range of 1 to 30 atmospheres.

14. The process of claim 1, wherein said feeding N₂ to the electrolytic cell comprises feeding gaseous nitrogen or air or liquid with dissolved nitrogen to the electrolytic cell.

15. A system for generating ammonia, the system comprising at least one electrochemical cell, which comprises at least one cathode electrode having a catalytic surface, wherein the catalytic surface comprises at least one catalyst comprising one or more transition metal sulfide.

16. The system of claim 14, wherein said one or more transition metal sulfide is selected from the group consisting of Yttrium sulfide, Scandium sulfide, Zirconium sulfide, Titanium sulfide, Vanadium sulfide, Chromium sulfide, Niobium sulfide, Nickel sulfide, Iron sulfide, Manganese sulfide, Cobalt sulfide, Iridium sulfide, Copper sulfide, Osmium sulfide, Ruthenium sulfide, Rhodium sulfide and combinations thereof.

17. The system of claim 14, wherein the catalyst surface comprises at least one surface having a Rocksalt structure, a NiAs-type structure, or a Pyrite structure.

18. The system of claim 14, wherein the catalyst surface comprises at least one surface having a (100) facet or a (111) facet.

19. The system of claim 14, wherein said electrolytic cell further comprises one or more electrolytic solution, preferably an acidic, neutral or alkaline aqueous solution.

20. The system of claim 19, wherein the electrolytic solution comprises an aqueous water-miscible organic solvent.

21. The system of claim 14, wherein the electrolytic cell comprises an anode within one cell compartment and a cathode within another cell compartment.
